(19) United States
(12) Patent Application Publication
(10) Pub. No.: US 2024/0166198 A1
(43) Pub. Date: May 23, 2024

(54) BEHAVIOR PLANNING DEVICE, VEHICLE CONTROL SYSTEM, AND BEHAVIOR PLAN GENERATION METHOD

(71) Applicant: Mitsubishi Electric Corporation, Tokyo (JP)

(72) Inventors: Hiroshi YAMADA, Tokyo (JP); Toru Higuchi, Tokyo (JP); Michitoshi Azuma, Tokyo (JP); Kohei Mori, Tokyo (JP); Takayuki Tanaka, Tokyo (JP); Nariaki Takehara, Tokyo (JP)

(73) Assignee: Mitsubishi Electric Corporation, Tokyo (JP)

(21) Appl. No.: 18/378,703

(22) Filed: Oct. 11, 2023

(30) Foreign Application Priority Data
Nov. 21, 2022 (JP) 2022-185525

(51) Int. Cl. B60W 30/09; B60W 60/00

(52) U.S. Cl. CPC B60W 30/09; B60W 60/001; B60W 2554/80

(57) ABSTRACT

This behavior planning device includes: an emergency stop requesting unit which detects abnormality on the basis of obstacle information acquired from an obstacle information acquisition unit and a roadside information acquisition unit and outputs an emergency stop request; a stop position determination unit which calculates a stop position of an own vehicle on the basis of the emergency stop request and determines whether or not the stop position is in an area where advancement of another traffic participant is obstructed; and a behavior plan generation unit which, in a case where it is determined that the own vehicle will stop in the area where advancement of another traffic participant is obstructed, such as an intersection, generates a behavior plan for causing the own vehicle to stop outside the area or after passing over the area.

### BACKGROUND OF THE INVENTION

### 1. Field of the Invention

The present disclosure relates to a behavior planning device, a vehicle control system, and a behavior plan generation method.

### 2. Description of the Background Art

In recent years, automated driving technology for automobiles have been increasingly developed, and not only driving assistance for a user but also technology for performing automated driving without user's operation is attracting attention. In performing automated driving, in a case where traveling cannot be performed safely as in a case where some of sensors for detecting the surrounding environment around the own vehicle fail, it is required to stop the vehicle in a situation with a low accident risk without obstructing another traffic participant.

For example, in Patent Document 1, when abnormality of an outside environment recognition device for recognizing the surrounding environment around the own vehicle is detected, processing for stopping the vehicle is executed.
Patent Document 1: Japanese Laid-Open Patent Publication No. 2022-24741

In Patent Document 1, in a case where abnormality has occurred in an outside environment recognition system for recognizing the own vehicle surrounding environment, a trajectory for the own vehicle to pass until stopping is generated on the basis of minimum risk maneuver (MRM), but there is inevitably a possibility that the vehicle stops in an area where roads intersect each other in an intersection or the like. Stopping the vehicle in an intersection might obstruct advancement of another traffic participant or cause collision between another traffic participant and the own vehicle. This is because the intersection is an area where roads intersect each other and where the own vehicle greatly influences another traffic participant. Also, in a case where the own vehicle stops at a road shoulder outside an intersection, the own vehicle might obstruct passage of another traffic participant that is to pass on a road connected to the road shoulder or through an entrance/exit of a parking lot, for example. These are problems in considering improvement in automated driving.

### SUMMARY OF THE INVENTION

The present disclosure has been made to solve the above problems, and an object of the present disclosure is to provide a behavior planning device, a vehicle control system, and a behavior plan generation method for stopping in an area where advancement of another traffic participant is not obstructed and another traffic participant is less influenced, when abnormality has occurred in a detector (sensor) for recognizing the surrounding environment around the own vehicle.

A behavior planning device according to the present disclosure is a behavior planning device which receives obstacle information around a mobile object acquired by an obstacle information acquisition unit, position information of the mobile object acquired by an own-position acquisition unit, road information around the mobile object acquired by a road information acquisition unit, and obstacle information around a roadside acquired by a roadside information acquisition unit, the behavior planning device including: an emergency stop requesting unit which outputs an emergency stop request when having detected abnormality for at least one of the obstacle information around the mobile object acquired by the obstacle information acquisition unit and the obstacle information around the roadside acquired by the roadside information acquisition unit; a stop position determination unit which determines whether or not the mobile object will stop in a first area where advancement of another traffic participant is obstructed at a time of stoppage of the mobile object, on the basis of the road information, the position information of the mobile object, and the emergency stop request outputted from the emergency stop requesting unit; and a behavior plan generation unit which generates a behavior plan for preventing the mobile object from stopping in the first area, in a case where the stop position determination unit has determined that the mobile object will stop in the first area where advancement of another traffic participant is obstructed.

According to the present disclosure, it becomes possible to generate a behavior plan for stopping in an area where advancement of another traffic participant is not obstructed and another traffic participant is less influenced.

### BRIEF DESCRIPTION OF THE DRAWINGS

FIG. 1 is a function block diagram showing the configurations of a behavior planning device and a vehicle control system according to the first embodiment of the present disclosure;

FIG. 2 shows an example of detection ranges for an obstacle by obstacle information detection units mounted to a vehicle;

FIG. 3 illustrates operation of a stop position determination unit of the behavior planning device according to the first embodiment;

FIG. 4 is a flowchart showing operations in the behavior planning device and the vehicle control system according to the first embodiment;

FIG. 5 is a function block diagram showing the configuration of a behavior plan generation unit of the behavior planning device according to the first embodiment;

FIG. 6 is a flowchart showing operation in the behavior plan generation unit of the behavior planning device according to the first embodiment;

FIG. 7 illustrates operation in the behavior plan generation unit of the behavior planning device according to the first embodiment;

FIG. 8 illustrates candidate routes generated by a candidate route generation unit according to the first embodiment;

FIG. 9 illustrates traveling difficulties of candidate routes calculated by a route traveling difficulty calculation unit according to the first embodiment;

FIG. 10 illustrates a behavior decided by a behavior deciding unit according to the first embodiment;

FIG. 11 illustrates operation in a behavior plan generation unit of a behavior planning device according to the second embodiment of the present disclosure;

FIG. 12 illustrates traveling difficulties of candidate routes calculated by a route traveling difficulty calculation unit according to the second embodiment;

FIG. 13 illustrates a behavior decided by a behavior deciding unit according to the second embodiment;

FIG. 14 is a function block diagram showing the configurations of a behavior planning device and a vehicle control system according to the third embodiment of the present disclosure;

FIG. 15A is a flowchart showing operation in the behavior planning device according to the third embodiment;

FIG. 15B is a flowchart showing operation in the behavior planning device according to the third embodiment;

FIG. 16 illustrates operation in a behavior plan generation unit of the behavior planning device according to the third embodiment;

FIG. 17 illustrates traveling difficulties of candidate routes calculated by a route traveling difficulty calculation unit according to the third embodiment;

FIG. 18 illustrates a behavior decided by a behavior deciding unit according to the third embodiment;

FIG. 19 shows a hardware configuration of the vehicle control system according to each of the first to third embodiments; and

FIG. 20 shows another example of a hardware configuration of the vehicle control system according to each of the first to third embodiments.

### DETAILED DESCRIPTION OF THE PREFERRED EMBODIMENTS OF THE INVENTION

Hereinafter, embodiments of a behavior planning device, a vehicle control system, and a behavior plan generation method according to the present disclosure will be described with reference to the drawings. In the following embodiments, an automobile is used as an example of a mobile object to which the behavior planning device and the vehicle control system are applied, and an example in which a behavior plan for the own vehicle is generated is shown. The mobile object is assumed to be capable of traveling by automated driving corresponding to level 3 or level 4 defined by Society of Automotive Engineers (SAE) International, for example. It is assumed that the mobile object has acquired a traveling route to a destination in advance and is traveling along the route. In the drawings, the same reference characters denote the same or corresponding parts. Therefore, the detailed description thereof may be omitted to avoid repeating the description.

### First Embodiment

Hereinafter, a behavior planning device, a vehicle control system, and a behavior plan generation method according to the first embodiment of the present disclosure will be described with reference to the drawings.

### <Device Configuration>

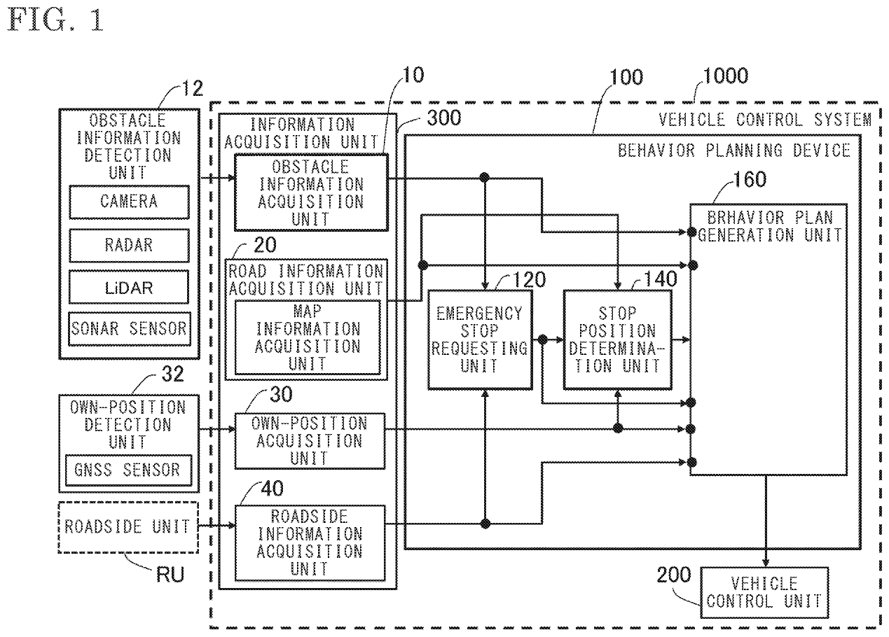

FIG. 1 is a function block diagram showing the configurations of the behavior planning device and the vehicle control system according to the first embodiment. In FIG. 1, a vehicle control system 1000 includes a behavior planning device 100. The behavior planning device 100 is a device for planning a behavior of the own vehicle, and includes an emergency stop requesting unit 120, a stop position determination unit 140, and a behavior plan generation unit 160 which performs calculation so as to generate such a behavior that reduces influence on the surroundings. The vehicle control system 1000 includes an information acquisition unit 300 which acquires information needed for generating a behavior plan for the own vehicle in the behavior planning device 100, and the information acquired by the information acquisition unit 300 is inputted to the behavior planning device 100. The information acquisition unit 300 includes an obstacle information acquisition unit 10 which acquires obstacle information around the own vehicle, a road information acquisition unit 20, an own-position acquisition unit 30 which acquires position information of the own vehicle, and a roadside information acquisition unit 40 which acquires information from a roadside unit RU. Further, the vehicle control system 3000 includes a vehicle control unit 200 and controls actuators for driving the vehicle, such as a brake and a steering wheel, on the basis of the behavior plan generated by the behavior planning device 300.

In FIG. 1, the obstacle information acquisition unit 10, the road information acquisition unit 20, the own-position acquisition unit 30, and the roadside information acquisition unit 40 may be included in the behavior planning device 100.

The obstacle information acquisition unit 10 acquires information of an obstacle present around the own vehicle, detected from an obstacle information detection unit 12.

The obstacle information detection unit 12 detects obstacle information. Obstacles are, for example, traffic participants such as another vehicle, a pedestrian, a bicycle, and a motorcycle present around the own vehicle. The obstacle information detection unit 12 is at least one of a camera, a radar, a light detection and ranging (LiDAR) device, and a sonar sensor provided to the own vehicle, for example. The obstacle information detection unit 12 may output, to the obstacle information acquisition unit 10, obstacle information in which an obstacle present around the own vehicle is associated with the type of the traffic participant classified into another vehicle, a pedestrian, a bicycle, a motorcycle, or the like.

The cameras are provided at such positions that the cameras can take images in frontward, lateral, and rearward directions from the own vehicle. From the taken images, information indicating the environment around the vehicle, such as information of obstacles and lanes frontward of the own vehicle, is acquired.

The radar radiates a radar wave frontward of the own vehicle and detects a reflected wave thereof, thereby measuring a relative distance and a relative speed of an obstacle present frontward of the own vehicle, and outputs the measurement result.

The LiDAR device radiates a laser beam to an area around the own vehicle and detects a time difference until the laser beam is reflected and returns from a surrounding object, thereby detecting the position of the object.

The sonar sensor radiates an ultrasonic wave to an area around the own vehicle and detects a time difference until the ultrasonic wave is reflected and returns from a surrounding object, thereby detecting the position and the distance at which the object is present.

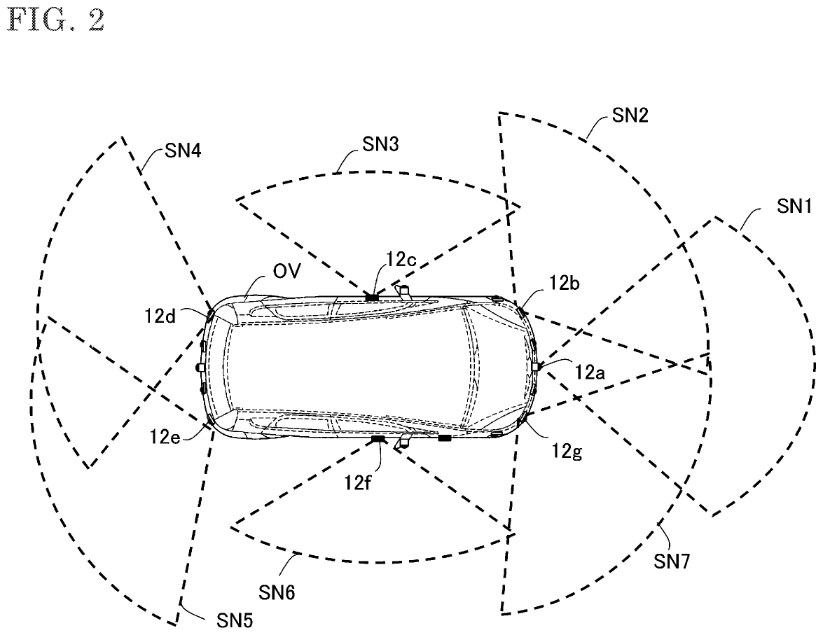

FIG. 2 shows an example in which a plurality of the obstacle information detection units 12 described above are combined and provided to the vehicle, and shows detection ranges of the respective obstacle information detection units 12. In FIG. 2, seven obstacle information detection units 12, i.e., obstacle information detection units 12a to 12g, are mounted to the own vehicle OV, three obstacle information detection units 12a, 12b, 12g are located on the front side, two obstacle information detection units 12c, 12f are located on the lateral sides, and two obstacle information detection units 12d, 12e are located on the rear side. The detection ranges of the respective obstacle information detection units 12 are shown by sector-shaped broken lines. The own vehicle OV can detect obstacles in detection ranges SN1, SN2, SN7 in the frontward area, detection ranges SN3, SN6 in the lateral areas, and detection ranges SN4, SN5 in the rearward area. The number of the obstacle information detection units 12 is not limited to seven. However, it is desirable that the detection ranges for obstacles can be set so as to cover the whole surrounding area around the own vehicle OV.

The road information acquisition unit 20 acquires information of roads around the own vehicle from a road information detection unit (not shown).

The road information acquisition unit 20 includes a map information acquisition unit which has acquired map data of a planned traveling route for the own vehicle in advance, and acquires road information around the own vehicle on the basis of own-vehicle position information detected by an own-position detection unit 32.

Here, the map data includes road information made up of center lines of lanes on which the own vehicle travels, lane widths, stop lines of intersections, the numbers of branches of intersections such as a T junction and a crossroad, stop lines of intersections, and diverging start positions.

Road information to be included in the map data may be acquired from a surrounding structure detection result obtained from at least one of the camera, the radar, the LiDAR device, and the sonar sensor which are the obstacle information detection units 12 provided to the own vehicle.

The own vehicle is provided with a global navigation satellite system (GNSS) sensor as the own-position detection unit 32, in order to identify the position of the own vehicle. A GNSS antenna is connected to the GNSS sensor, and a positioning signal from a positioning satellite moving along a satellite orbit is received by the GNSS antenna. The received positioning signal is analyzed and information of the phase center of the GNSS antenna (such as latitude, longitude, altitude, and orientation) is outputted to the own-position acquisition unit 30.

The own position which is position information of the own vehicle may be acquired by, instead of the method using the GNSS sensor, simultaneous localization and mapping (SLAM) (simultaneous execution of own-position estimation and environment map generation) technology using a surrounding structure detection result acquired from at least one of the camera, the radar, the LiDAR device, and the sonar sensor.

For example, an obstacle information detection device (hereinafter, referred to as roadside unit) provided in a roadside area includes at least one of a camera, a radar, a LiDAR device, and a sonar sensor. The roadside information acquisition unit 40 acquires information around the roadside detected by the roadside unit RU, as obstacle information, via wireless communication. As well as in a roadside area, the roadside unit may be provided at a road such as a lane, a road shoulder, or a pavement, or may be provided to a building, a utility pole, or the like near a road. In addition, information around the roadside may be acquired from a remote traffic control system or the like.

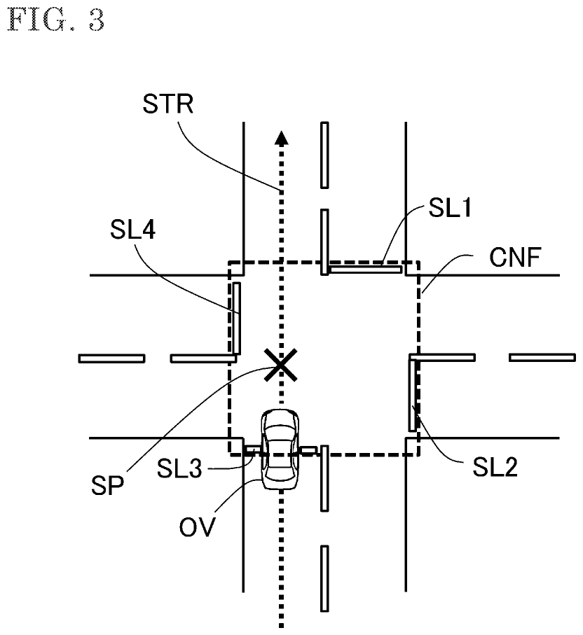

In FIG. 3, the obstacle information acquisition unit 10, the road information acquisition unit 20, the own-position acquisition unit 30, and the roadside information acquisition unit 40 are shown so as not to be included in the behavior planning device 100. This configuration is suitable for remote control for the own vehicle by traffic control. As an example, a configuration including the emergency stop requesting unit 120, the stop position determination unit 140, and the behavior plan generation unit 160, and a configuration including the obstacle information acquisition unit 10, the road information acquisition unit 20, the own-position acquisition unit 30, and the roadside information acquisition unit 40, are provided separately from each other. Specifically, the obstacle information acquisition unit 10, the road information acquisition unit 20, the own-position acquisition unit 30, and the roadside information acquisition unit 40 are provided in the own vehicle, and the emergency stop requesting unit 120, the stop position determination unit 140, and the behavior plan generation unit 160 are provided on the traffic control side, as the behavior planning device 100. Without limitation thereto, the configurations may be reverse to each other, for example.

On the basis of obstacle information acquired from the obstacle information acquisition unit 10 and obstacle information acquired from the roadside information acquisition unit 40, the emergency stop requesting unit 120 detects whether or not abnormality has occurred for the obstacle information, and if abnormality is detected, the emergency stop requesting unit 120 outputs an emergency stop request.

Here, a method for detecting abnormality that has occurred for obstacle information will be described.

First, an example about abnormality for obstacle information acquired from the roadside information acquisition unit 40 will be described. As abnormality for obstacle information acquired from the roadside information acquisition unit 40, there is communication disruption. Whether or not communication disruption has occurred can be determined by providing a signal counted up per certain cycle from a roadside unit to the roadside information acquisition unit 40. If an event in which count-up per certain cycle is not done is detected, this can be considered to mean that communication from the roadside unit to the roadside information acquisition unit 40 is disrupted. In this way, the emergency stop requesting unit 120 determines communication disruption on the basis of obstacle information acquired from the roadside information acquisition unit 40, thus detecting abnormality.

Next, an example about abnormality for obstacle information acquired from the obstacle information detection unit 12 provided to the own vehicle will be described. As abnormality for obstacle information acquired from the obstacle information detection unit 12 provided to the own vehicle, there are communication disruption and reduction in the detection range. Communication disruption can be determined by using a signal counted up per certain cycle, whereby abnormality can be detected, as with the communication disruption from the roadside unit to the roadside information acquisition unit.

Regarding whether or not the detection range is reduced, snow or the like may be adhered around the sensor which is the obstacle information detection unit 12, and the detection range reduction can be determined by confirming whether or not a state in which the measurement distance is not greater than a predetermined threshold has been detected for a predetermined period. That is, in a case where snow or the like is adhered so as to cover a part of the sensor, the detection range is reduced as compared to the normal range, and thus abnormality can be detected. As another example, it is assumed that some of imaging elements of the camera fail, so that some pixels of the camera image have no colors or have not changed in colors for a predetermined period. Thus, the detection range is reduced and abnormality can be detected.

The stop position determination unit 140 determines whether or not the own vehicle will enter and stop in an area where another traffic participant is greatly influenced, in a case of stopping from the present position, on the basis of the road information acquired from the road information acquisition unit 20, the own position acquired from the own-position acquisition unit 30, and the emergency stop request outputted from the emergency stop requesting unit 120.

Here, as a method for calculating the stop position, the present position may be calculated directly as the stop position, or the stop position may be calculated using a speed (deceleration) that can be produced by the own vehicle in a case of stopping from the present vehicle speed, for example.

Whether or not the calculated stop position of the own vehicle is in an area where another traffic participant is greatly influenced is determined on the basis of the road information acquired by the road information acquisition unit 20. The area where another traffic participant is greatly influenced refers to an area where advancement of another traffic participant is obstructed when the own vehicle is stopped at the position, and specific examples thereof are an area on the inner side of stop lines of an intersection, a diverging start position on an expressway, and the like, i.e., an “area where roads intersect each other”. Hereinafter, the “area where another traffic participant is greatly influenced” is referred to as an “area where advancement of another traffic participant is obstructed”.

Next, an example of a method for determining whether or not the own vehicle will stop in an “area where advancement of another traffic participant is obstructed”, will be described with reference to FIG. 3. FIG. 3 illustrates operation of the stop position determination unit of the behavior planning device according to the first embodiment. In FIG. 3, the own vehicle OV traveling on the left side is about to enter an intersection, and a rectangular area indicated by a broken line connecting stop lines SL1, SL2, SL3, SL4 of lanes forming the intersection is an intersection area CNF. Here, the inner side of the stop lines SL1, SL2, SL3, SL4 of the intersection, i.e., the inside of the area CNF is an “area where advancement of another traffic participant is obstructed”.

First, position information of the stop lines SL1, SL2, SL3, SL4 forming the intersection is inputted from the road information acquisition unit 20 to the stop position determination unit 140. By connecting pieces of position information of the stop lines SL1, SL2, SL3, SL4, the area CNF represented by a rectangular shape can be generated. Then, if the stop position of the own vehicle OV is present inside the area CNF, it is determined that the own vehicle OV will stop in the area where advancement of another traffic participant is obstructed.

Next, the stop position of the own vehicle OV is calculated.

Center line information of the lane on which the own vehicle travels is acquired from the road information acquisition unit 20. Here, this information is assumed to be a straight route STR of a target route to be followed by the own vehicle. Then, the stop position of the own vehicle OV is represented by a stop position SP on the straight route STR in FIG. 3. The stop position SP of the own vehicle OV is calculated using the deceleration of the own vehicle OV on the straight route STR.

In FIG. 3, the gravity center position of the own vehicle OV at a time of stoppage is represented by the stop position SP. If this position is present in the intersection area CNF, it is determined that the own vehicle OV will enter the area where advancement of another traffic participant is obstructed at a time of stoppage.

The stop position SP may be any position that allows the own vehicle OV to be identified, such as the front end position or the rear end position of the own vehicle OV. Regarding whether or not the stop position SP is present in the area CNF, a rectangular shape according to the size of the own vehicle OV (a simulated outer shape of the own vehicle) may be generated from the position thereof (stop position), and if a part of the rectangular shape is present inside the intersection area CNF, it may be determined that the own vehicle OV will enter the area where advancement of another traffic participant is obstructed at a time of stoppage of the own vehicle OV.

In the above description, as the area where advancement of another traffic participant is obstructed, the area CNF corresponding to the intersection area is generated on the basis of the position information of the stop lines of the intersection inputted from the road information acquisition unit 20. However, the present disclosure is not limited thereto. As the area where another traffic participant is greatly influenced, the area CNF may be inputted to the stop position determination unit 140 directly on the basis of information such as intersection information that the road information acquisition unit 20 has. As another example, using diverging start position information that the road information acquisition unit 20 has, an area including a diverging start position may be set as the area CNF. Thus, the area CNF may be set without limitation to the intersection area.

As described above, the stop position determination unit 140 determines whether or not the own vehicle OV will enter and stop in the area where advancement of another traffic participant is obstructed in a case where the own vehicle OV stops from the present position.

Next, the behavior plan generation unit 160 will be described.

The behavior plan generation unit 160 generates a behavior plan for preventing the own vehicle from stopping in the area where advancement of another traffic participant is obstructed, on the basis of the obstacle information around the own vehicle outputted from the obstacle information acquisition unit 10, the road information outputted from the road information acquisition unit 20, the own position outputted from the own-position acquisition unit 30, the obstacle information outputted from the roadside information acquisition unit 40, the emergency stop request outputted from the emergency stop requesting unit 120, and a determination result outputted from the stop position determination unit 140 about whether or not the own vehicle will enter and stop in the area where advancement of another traffic participant is obstructed.

Specifically, the behavior plan for the own vehicle generated by the behavior plan generation unit 160 includes a target route, a target speed, and a target position for the own vehicle to travel. In addition, the behavior plan may include information indicating upper and lower limits of the acceleration for the own vehicle to travel and the steering angle for following the target route.

<Operations of Vehicle Control System 1000 and Behavior Planning Device 100>

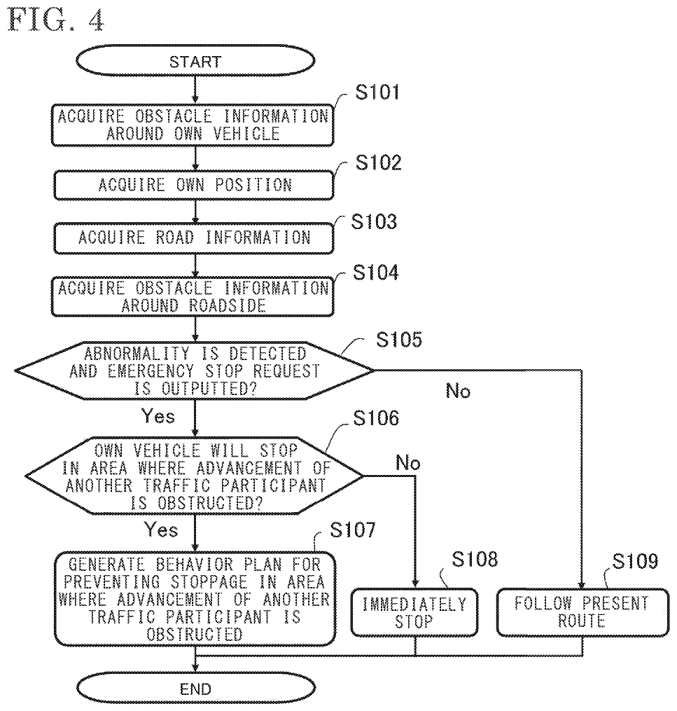

Next, operations of the vehicle control system 1000 and the behavior planning device 100 according to the first embodiment will be described with reference to a flowchart in FIG. 4. The process in the flowchart in FIG. 4 is repeatedly executed during traveling of the own vehicle. Steps in FIG. 4 will be described in association with the function units shown in the function block diagram in FIG. 1.

First, in step S101, the obstacle information acquisition unit 10 acquires information of an obstacle present around the own vehicle, outputted from the obstacle information detection unit 12.

In step S102, the own-position acquisition unit 30 acquires the own position outputted from the own-position detection unit 32.

In step S103, the road information acquisition unit 20 acquires road information outputted from the road information detection unit (not shown) or road information of the map information acquisition unit.

In step S104, the roadside information acquisition unit 40 acquires roadside information outputted from the roadside unit PU.

In step S105, on the basis of obstacle information outputted from the obstacle information acquisition unit 10 and obstacle information outputted from the roadside information acquisition unit 40, the emergency stop requesting unit 120 detects whether or not abnormality has occurred for the obstacle information, and when having detected abnormality, the emergency stop requesting unit 120 outputs an emergency stop request. If abnormality is detected and a stop request is outputted (Yes in step S105), the process proceeds to step S106. If abnormality is not detected, a stop request is not outputted (No in step S105) and therefore the process proceeds to step S109.

If the process proceeds to step S106, the stop position determination unit 140 determines whether or not the own vehicle will stop in the area where advancement of another traffic participant is obstructed in a case where the own vehicle stops from the present position. If the own vehicle will stop in the area where advancement of another traffic participant is obstructed (Yes in step S106), the process proceeds to step 3107. If the own vehicle will stop without entering the area where advancement of another traffic participant is obstructed (No in step S106), the process proceeds to step 3308.

If the process proceeds to step S107, the behavior plan generation unit 160 generates a behavior plan for preventing the own vehicle from stopping in the area where advancement of another traffic participant is obstructed.

If the process proceeds to step S108, the behavior plan generation unit 160 performs output so that the own vehicle immediately stops, because the stop position of the own vehicle is not in the area where advancement of another traffic participant is obstructed.

If the process proceeds to step S109, the behavior plan generation unit 160 performs output so that the own vehicle continues to travel while following the route on which the own vehicle is traveling at present.

The output of the behavior plan generation unit 160 based on each of steps S107 to S109 is inputted to the vehicle control unit 200, which thus controls the actuators (not shown) for driving the vehicle, such as the brake and the steering wheel.

As described above, in the behavior planning device 300, if it is determined that the own vehicle will stop in the area where advancement of another traffic participant is obstructed, a behavior plan for preventing the own vehicle from stopping in the area where advancement of another traffic participant is obstructed is generated, and if it is determined that the own vehicle will stop outside the area where advancement of another traffic participant is obstructed, output is performed so as to immediately stop the own vehicle. In addition, if an emergency stop request is not generated, a behavior plan is generated so as to continue to travel while following the route on which the own vehicle is traveling at present.

<Process in Behavior Plan Generation Unit 160>

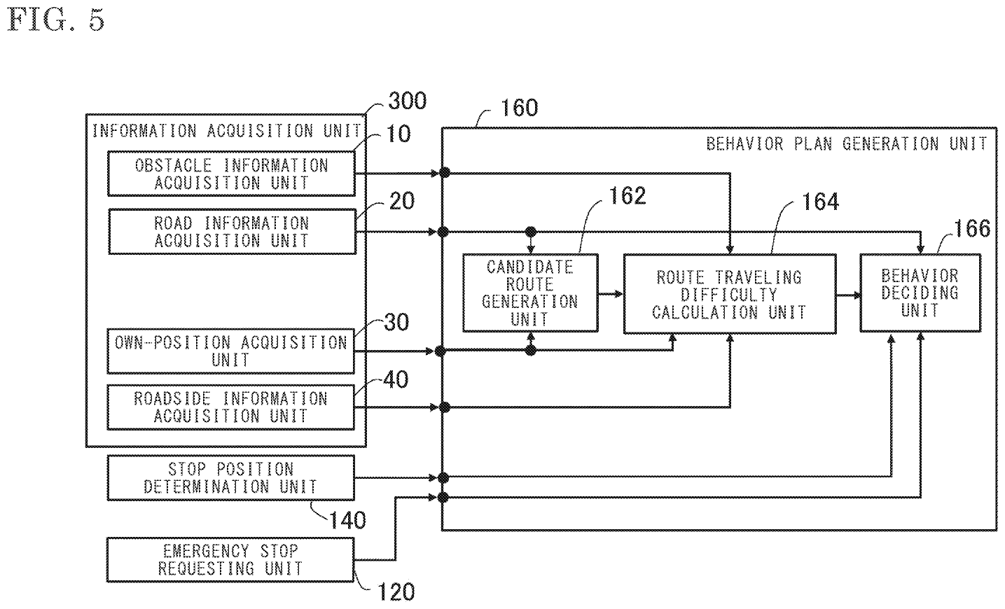

Next, a process for the behavior plan generation unit 160 to generate a behavior plan that causes less influence on the surroundings will be described. FIG. 5 is a function block diagram showing the configuration of the behavior plan generation unit 160. In FIG. 5, the behavior plan generation unit 160 includes a candidate route generation unit 162, a route traveling difficulty calculation unit 164, and a behavior deciding unit 166.

The candidate route generation unit 162 generates a route that can be selected by the own vehicle, as a candidate route, on the basis of the road information acquired by the road information acquisition unit 20 and the own position acquired by the own-position acquisition unit 30.

Here, the candidate route will be described. In a case of turning right at a crossroad intersection, the road information acquired from the road information acquisition unit 20 is only route information for turning right. However, on the basis of information indicating the crossroad intersection, the candidate route generation unit 162 generates also a route for advancing straight and a route for turning left, as candidate routes. In a case of turning right at a T junction intersection having no straight route, the road information acquired from the road information acquisition unit 20 is only route information for turning right, but on the basis of information indicating the T junction intersection, the candidate route generation unit 162 generates also a route for turning left, as a candidate route.

Regarding each route generated by the candidate route generation unit 162, the route traveling difficulty calculation unit 164 calculates a difficulty for traveling on the generated candidate route on the basis of the obstacle information acquired from the obstacle information acquisition unit 10 and the obstacle information outputted from the roadside information acquisition unit 40. The traveling difficulty of the route will be described later.

The behavior deciding unit 166 selects a route having the lowest traveling difficulty on the basis of the candidate routes and their respective traveling difficulties calculated by the route traveling difficulty calculation unit 164, and generates a behavior for preventing stoppage in the area where advancement of another traffic participant is obstructed. That is, the stop position is set in the area where another traffic participant is less influenced, to lead the own vehicle.

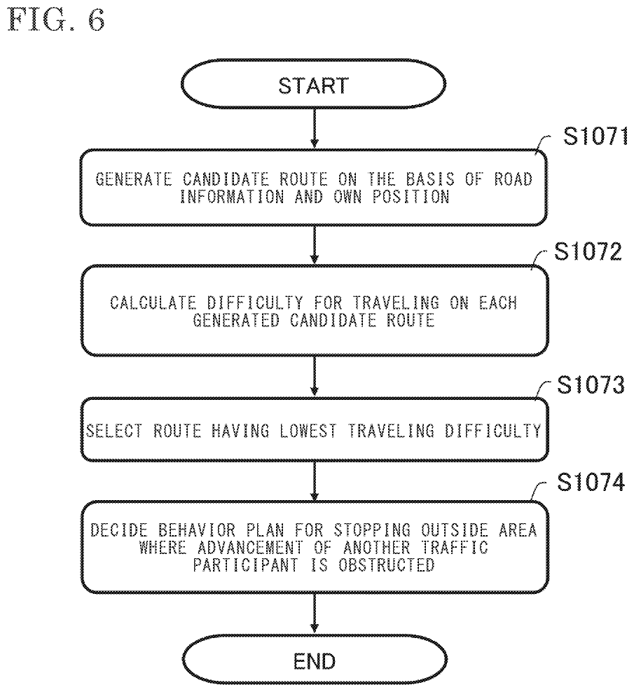

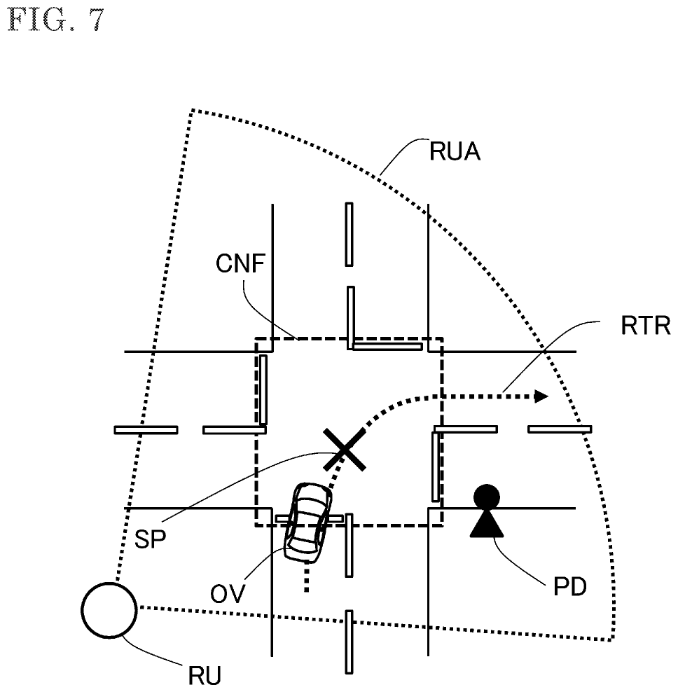

Next, the process for the behavior plan generation unit 160 to generate a behavior plan that causes less influence on the surroundings will be described with reference to a flowchart shown in FIG. 6. The process in the flowchart in FIG. 6 is the detailed process of operation in step S107 in FIG. 4. Steps in FIG. 7 will be described in association with the function units shown in the function block diagram in FIG. 5.

First, in step S1071, the candidate route generation unit 162 generates at least one candidate route on the basis of the road information acquired from the road information acquisition unit 20 and the own position acquired from the own-position acquisition unit 30.

In step S1072, regarding each candidate route generated by the candidate route generation unit 162, the route traveling difficulty calculation unit 164 calculates a traveling difficulty for the own vehicle to travel, on the basis of the obstacle information acquired from the obstacle information acquisition unit 10 and the obstacle information acquired from the roadside information acquisition unit 40.

In step S1073, the behavior deciding unit 166 selects a route having the lowest traveling difficulty among the traveling difficulties of the candidate routes calculated by the route traveling difficulty calculation unit 164.

In step S1074, on the basis of the selected route, the behavior deciding unit 166 generates a behavior plan for leading the own vehicle so as to avoid the area where advancement of another traffic participant is obstructed and stop in an area where advancement of another traffic participant is not obstructed and another traffic participant is less influenced, and outputs the behavior plan to the vehicle control unit 200.

<Operation of Behavior Planning Device 100>

Next, the detailed operation of the behavior planning device 100 will be described with reference to FIG. 7 to FIG. 10.

FIG. 7 illustrates a detailed operation example of the behavior planning device 100 and shows a situation in which an emergency stop request is outputted from the emergency stop requesting unit 120 in the own vehicle OV to pass through the intersection by turning right. In FIG. 7, the inner side of the stop lines of the intersection is represented as an area CNF where advancement of another traffic participant is obstructed. In addition, a roadside unit RU can detect an obstacle in an area RUA indicated by a dotted-line sector shape, and has detected a pedestrian PD here. That is, the roadside information acquisition unit 40 acquires the pedestrian PD as obstacle information. The own vehicle OV acquires obstacle information acquired by the roadside unit PU and the obstacle information detection units 12 which are the obstacle detection sensors provided to the own vehicle OV.

First, with reference to FIG. 7, a situation before an emergency stop request is outputted from the emergency stop requesting unit 120 will be described.

On the basis of a right-turn route PTR passing the lane center and generated so as to pass through the intersection by turning right, which is acquired from the road information acquisition unit 20, and the position information acquired from the own-position acquisition unit 30, the own vehicle OV travels while following the right-turn route RTR and caring about movement of the pedestrian PD acquired as the obstacle information into the right-turn route RTR.

Here, regarding the obstacle information acquired from the obstacle information acquisition unit 10, the emergency stop requesting unit 120 detects that the obstacle information detection unit 12 (obstacle detection sensor) for detecting the right side of the own vehicle OV has failed, and thus detects abnormality. Then, the emergency stop requesting unit 120 outputs an emergency stop request to the stop position determination unit 140 and the behavior plan generation unit 160.

The stop position determination unit 140 calculates the stop position SP at which the own vehicle OV will advance and stop in a case of stopping from the present position on the basis of the emergency stop request. As shown in FIG. 7, the stop position SP is set in the intersection which is the inside of the area CNF, and if the own vehicle OV stops on the inner side of the stop lines of the intersection, advancement of another vehicle is obstructed. Then, the stop position determination unit 140 determines that the own vehicle OV will stop in the area CNF, and outputs the determination result to the behavior plan generation unit 160.

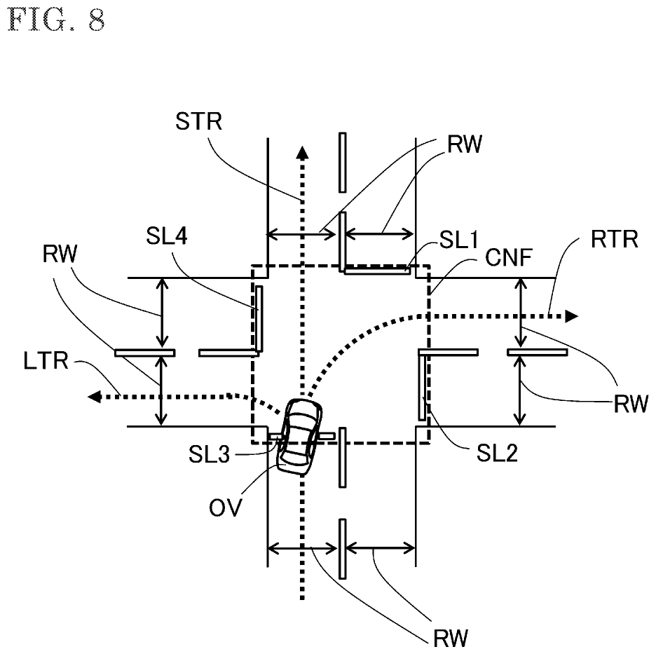

From the determination result of the stop position determination unit 140, the candidate route generation unit 162 of the own vehicle OV generates at least one candidate route on the basis of the own-position information acquired from the own-position acquisition unit 30 and the road information acquired from the road information acquisition unit 20. Specifically, on the basis of information corresponding to the type of the intersection, i.e., crossroad, information of the stop lines SL, and information of a road width PW, which are acquired from the road information acquisition unit, the exiting direction of the intersection is determined and a route leading to the exiting direction from the own position where the own vehicle OV is present is generated. FIG. 8 shows an example of candidate routes generated by the candidate route generation unit 162, and these candidate routes are based on the situation of the own vehicle in FIG. 7. That is, a straight route STR for advancing straight, a left-turn route LTR for turning left, and a right-turn route RTR for turning right are generated. Then, the generated candidate routes are outputted to the route traveling difficulty calculation unit 164.

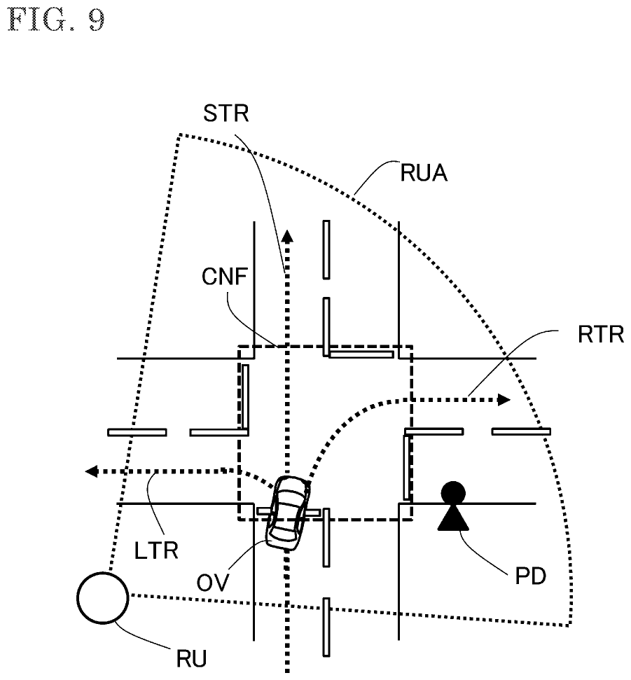

FIG. 9 illustrates a traveling difficulty of each candidate route. Regarding each of the candidate routes generated by the candidate route generation unit 162, i.e., the straight route STR, the left-turn route LTR, and the right-turn route RTR, the route traveling difficulty calculation unit 164 calculates a traveling difficulty for the own vehicle to travel on the candidate route, using the obstacle information acquired from the obstacle information acquisition unit 10, the own-position information acquired from the own-position acquisition unit 30, and the roadside information acquired from the roadside information acquisition unit 40. A specific calculation method will be described below.

In the emergency stop requesting unit 120, it has been determined that the obstacle information detection unit 12 for detecting the right side of the own vehicle OV has failed. Therefore, on the right side of the own vehicle OV, the detectable area is narrowed. In a case where the obstacle information detection units 12 provided to the own vehicle OV are normal, the own vehicle OV travels with redundancy enhanced using the obstacle information acquired by the obstacle information acquisition unit 10 and the obstacle information acquired by the roadside information acquisition unit 40. On the other hand, in the situation in which the detection area on the right side of the own vehicle OV is narrowed, if the own vehicle OV travels on the right-turn route RTR for turning right at the intersection, there is a possibility that the own vehicle will be late in coping with the behavior of the pedestrian PD, e.g., its movement into the road, even though the roadside unit RU detects that the pedestrian PD is present near the right-turn route RTR. Therefore, the difficulty for traveling through the right-turn route RTR is calculated to be high.

Next, regarding the left-turn route LTR, it is determined that there are no obstacles therearound, on the basis of the acquisition results from the roadside information acquisition unit 40 and the obstacle information acquisition unit 10 at the present position. However, since the own vehicle OV has been planned to turn right, the steering amount of the steering wheel increases. Therefore, the traveling difficulty of the left-turn route LTR is calculated to be middle.

Regarding the straight route STR, it can be determined that there are no obstacles ahead of the area CNF, on the basis of the acquisition result from the roadside information acquisition unit 40 and results from the obstacle information detection units 12 provided to the own vehicle OV. Here, since the steering amount of the steering wheel for the straight route STR is smaller than that for the left-turn route LTR, the traveling difficulty of the straight route STR is calculated to be low.

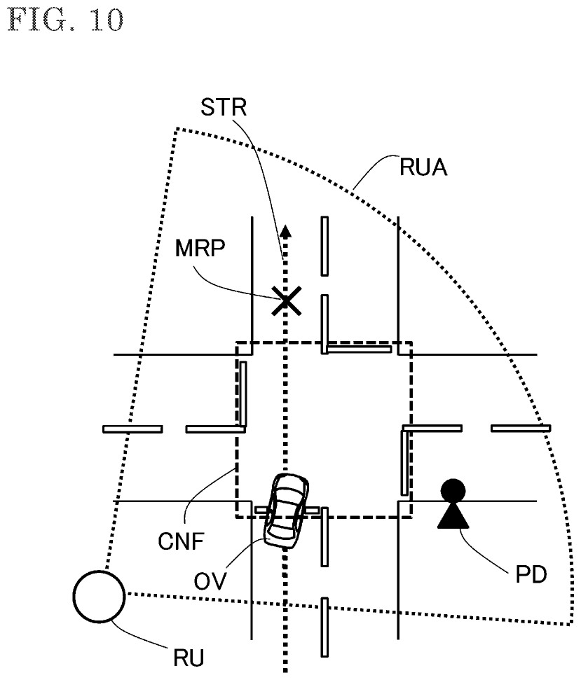

The candidate routes LTR, ST, PTR in the three directions and the calculation results of their respective traveling difficulties described above are outputted to the behavior deciding unit 166. As shown in FIG. 10, the behavior deciding unit 166 selects the straight route STR having the lowest traveling difficulty, as a route for the own vehicle OV to advance. Then, the behavior plan generation unit 160 outputs a behavior plan of stopping at a stop position MRP after passing over the area CNF where advancement of another traffic participant is obstructed, on the route.

In the example of calculation of the traveling difficulties of the candidate routes described above, if abnormality of the obstacle information detection unit 12 for detecting the right side of the own vehicle OV is detected and the own vehicle has been planned to travel through the straight route STR, the traveling difficulties are respectively calculated such that the traveling difficulty of the right-turn route RTR is high, the traveling difficulty of the straight route STR is low, and the traveling difficulty of the left-turn route LTR is middle.

In addition, if abnormality of the obstacle information detection unit 12 for detecting the right side of the own vehicle OV is detected and the own vehicle has been planned to travel through the left-turn route LTR, the traveling difficulties are respectively calculated such that the traveling difficulty of the right-turn route RTR is high, the traveling difficulty of the straight route STR is middle, and the traveling difficulty of the left-turn route LTR is low.

In the above description, the example in which abnormality of the obstacle information detection unit 12 for detecting the right side of the own vehicle OV is detected has been shown. However, also in a case where abnormality is detected for obstacle information from the roadside information acquisition unit 40, the behavior of the pedestrian PD on the right side is to be detected by only the obstacle information detection unit 12, and therefore traveling difficulties similar to the above ones are calculated.

As described above, according to the first embodiment, the behavior planning device includes the emergency stop requesting unit, the stop position determination unit, and the behavior plan generation unit. The emergency stop requesting unit detects abnormality on the basis of obstacle information acquired from the obstacle information acquisition unit and the roadside information acquisition unit, and if abnormality is detected, outputs an emergency stop request. The stop position determination unit calculates the stop position of the own vehicle on the basis of the emergency stop request, and determines whether or not the own vehicle will stop in an area where advancement of another traffic participant is obstructed, such as an intersection. If it is determined that the own vehicle will stop in the area where advancement of another traffic participant is obstructed, such as an intersection, the behavior plan generation unit generates a behavior plan for causing the own vehicle to stop outside the area or after passing over the area. Then, in accordance with the generated behavior plan, the vehicle control unit of the vehicle control system drives the actuators. Thus, it becomes possible to stop the own vehicle in an area where advancement of another traffic participant is not obstructed and another traffic participant is less influenced.

The behavior plan generation unit of the behavior planning device includes the candidate route generation unit, the route traveling difficulty calculation unit, and the behavior deciding unit. The candidate route generation unit generates at least one candidate route on the basis of road information acquired by the road information acquisition unit and an own position acquired by the own-position acquisition unit. The route traveling difficulty calculation unit calculates a traveling difficulty for traveling on each candidate route, on the basis of the obstacle information acquired by the obstacle information acquisition unit, the obstacle information acquired by the roadside information acquisition unit, and the abnormality detection information. The behavior deciding unit selects a route having a low traveling difficulty. This provides an effect of making it possible to select such a route that another traffic participant is less influenced among routes passing through the area, as well as generating a behavior plan for stopping the own vehicle after passing over the area.

### Second Embodiment

Hereinafter, a behavior planning device, a vehicle control system, and a behavior plan generation method according to the second embodiment of the present disclosure will be described with reference to the drawings.

The configurations of the behavior planning device and the vehicle control system according to the second embodiment are the same as those in FIG. 1 and FIG. 5 in the first embodiment, and description thereof is omitted.

### <Operation of Behavior Planning Device 100>

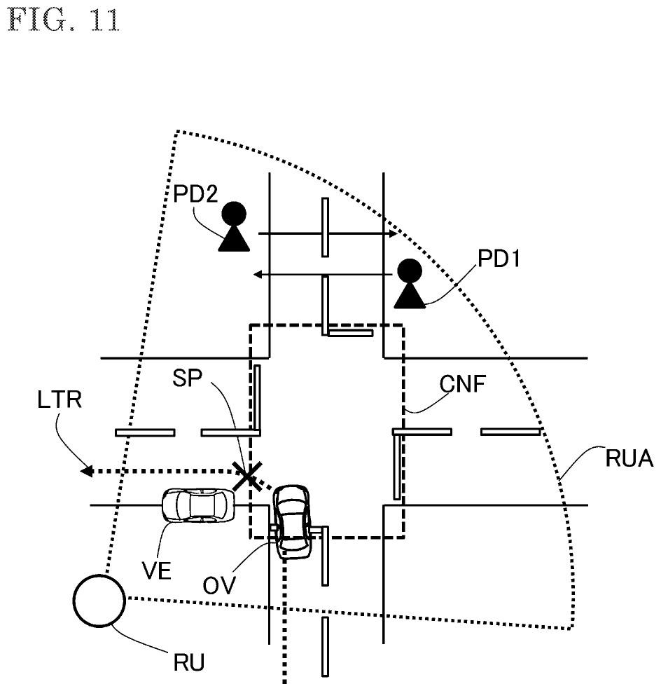

Operation of the behavior planning device 100 according to the second embodiment will be described with reference to FIG. 11 to FIG. 13.

FIG. 11 illustrates a detailed operation example of the behavior planning device 100 according to the second embodiment, and shows a case where, using obstacle information acquired from the roadside unit RU and the obstacle information detection units 12 provided to the own vehicle OV, the own vehicle OV travels while following the left-turn route LTR acquired from the road information acquisition unit 20, thus passing through an intersection by turning left. As in the first embodiment, the inner side of the stop lines of the intersection is represented as an area CNF where advancement of another traffic participant is obstructed. However, the present embodiment is different in that the width of the road in the direction in which the own vehicle OV turns right/left is greater than the width of the road in the direction in which the own vehicle OV advances straight. In addition, the roadside unit RU can detect an obstacle in an area RUA. Here, it is detected that pedestrians PD1, PD2 are about to cross the road at a position ahead of the intersection as seen from the own vehicle OV, and another vehicle VE is stopped on a side of the road at a position after the own vehicle OV passes over the intersection by turning left. That is, the roadside information acquisition unit 40 acquires the pedestrians PD1, PD2 and the other vehicle VE (static obstacle) as obstacle information.

On the basis of the left-turn route LTR passing the lane center and generated so as to pass through the intersection by turning left, which is acquired from the road information acquisition unit 20, and the position information acquired from the own-position acquisition unit 30, the own vehicle OV not only travels while following the left-turn route LTR but also travels while avoiding the other vehicle VE which is a static obstacle.

Here, regarding the obstacle information acquired from the obstacle information acquisition unit 10, the emergency stop requesting unit 120 determines that abnormality has occurred from a detection result indicating that the obstacle detection sensor for detecting the right side of the own vehicle OV has failed. Then, the emergency stop requesting unit 120 outputs an emergency stop request to the stop position determination unit 140 and the behavior plan generation unit 160.

The stop position determination unit 140 calculates the stop position SP at which the own vehicle OV will advance and stop in a case of stopping from the present position on the basis of the emergency stop request, as in the first embodiment. Then, as shown in FIG. 11, if the stop position SP is in the area CNF, the stop position determination unit 340 determines that the own vehicle OV will stop in the area CNF, and outputs the determination result to the behavior plan generation unit 160.

From the determination result of the stop position determination unit 140, the candidate route generation unit 162 of the own vehicle OV generates at least one candidate route on the basis of the own-position information acquired from the own-position acquisition unit 30 and the road information acquired from the road information acquisition unit 20. The generation method for the candidate route is the same as in the first embodiment. The candidate route generation unit 162 generates a straight route STR, a left-turn route LTP, and a right-turn route RTR and outputs them to the route traveling difficulty calculation unit 164.

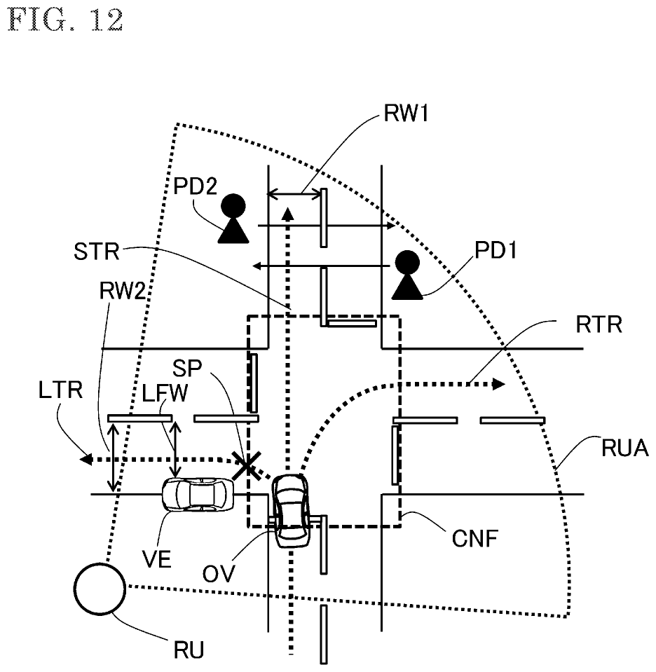

FIG. 12 illustrates a traveling difficulty of each candidate route. Regarding each of the routes generated by the candidate route generation unit 162, i.e., the straight route STR, the left-turn route LTR, and the right-turn route RTR, the route traveling difficulty calculation unit 164 calculates a traveling difficulty on the candidate route, using the obstacle information acquired from the obstacle information acquisition unit 10, the own-position information acquired from the own-position acquisition unit 30, and the roadside information acquired from the roadside information acquisition unit 40. In addition, the road information acquired from the road information acquisition unit 20 is also used, as necessary. A specific calculation method will be described below.

In the emergency stop requesting unit 120, it has been determined that the obstacle detection sensor provided on the right side of the own vehicle OV has failed. Therefore, on the right side of the own vehicle OV, the detectable area is narrowed. In the situation in which the detection area is narrowed, a traveling difficulty of a route for traveling in the corresponding direction, i.e., the right-turn route PTR, is calculated to be high.

Next, regarding the straight route STR, the roadside unit RU detects that the pedestrians PD1, PD2 are crossing the road at a position after the own vehicle OV passes over the intersection by advancing straight. Therefore, after passing over the intersection, it is necessary to care about presence of the pedestrians PD1, PD2, so that the traveling difficulty is calculated to be middle.

Regarding the left-turn route LTR, the roadside unit RU detects presence of the other vehicle VE stopped on the side of the road, as an obstacle. Therefore, for the left-turn route LTR, width information of the other vehicle VE present on the route is subtracted from a road width RW2, to calculate a remaining road width LFW with respect to the width of the left-turn route LTR. FIG. 12 illustrates a situation in which the width of the left-turn route LTR for the own vehicle OV is greater than a road width RW1 on the straight route STR in the straight advancement direction, and it is determined that the remaining road width LFW is greater than the width of the own vehicle OV by a predetermined value or more. Here, the fact that the remaining road width LFW is greater than the width of the own vehicle OV by a predetermined value or more means that it is not necessary to travel while straying onto another lane, and thus the influence of an obstacle on another lane can be reduced. Therefore, the traveling difficulty of the left-turn route LTR is also calculated to be middle.

The candidate routes LTR, STR, RTR in the three directions and the calculation results of their respective traveling difficulties described above are outputted to the behavior deciding unit 166. The behavior deciding unit 166 decides the candidate route for which the traveling difficulty is calculated to be lowest, as a route for the own vehicle OV to advance. Here, the traveling difficulties of the straight route STR and the left-turn route LTR have been calculated to be the same. In the case where the traveling difficulties have been calculated to be the same, the left-turn route LTR acquired from the road information acquisition unit 20, i.e., the originally planned left-turn route LTP, is decided to be prioritized.

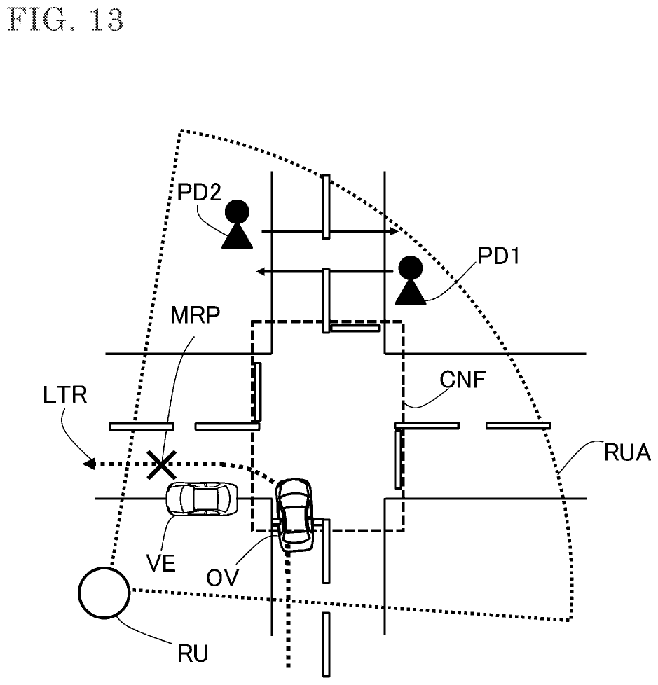

That is, as shown in FIG. 13, the left-turn route LTR is decided as a route for the own vehicle OV to advance. Then, the behavior plan generation unit 160 generates a behavior plan of stopping at the stop position MRP after passing over the area CNF on the route. The stop position MRP may be set at a position that is ahead of the other vehicle VE and where the other vehicle VE which is a static obstacle present on the left side of the own vehicle OV is no longer present.

In the present embodiment, the case of prioritizing the route acquired from the road information acquisition unit 20 has been described, but the present disclosure is not limited thereto. Traveling difficulties may be calculated in advance from only the candidate routes generated by the candidate route generation unit 162. For example, the order of traveling difficulties may be decided in advance such that the traveling difficulty of the straight route STR is low, the traveling difficulty of the left-turn route LTR is middle, and the traveling difficulty of the right-turn route RTR is high, and the behavior deciding unit 166 may decide the straight route STR as a traveling route in accordance with only the above order. In addition, in a case where the traveling difficulties of the straight route STR and the left-turn route LTR are the same level of middle as described in the second embodiment, the order decided in advance and the traveling difficulties calculated by the route traveling difficulty calculation unit may be combined to decide the straight route STR.

As described above, according to the second embodiment, the same effects as in the first embodiment are provided. That is, it is possible to stop the own vehicle in an area where advancement of another traffic participant is not obstructed and another traffic participant is less influenced, when abnormality is detected on the basis of obstacle information.

Further, in a case where a plurality of calculation results of the route traveling difficulty calculation unit are the same, a route matching a route acquired from the road information acquisition unit is prioritized, thus providing an effect that the traveling difficulty is minimized and also a behavior of following the route set as a target of the own vehicle can be performed.

### Third Embodiment

Hereinafter, a behavior planning device, a vehicle control system, and a behavior plan generation method according to the third embodiment of the present disclosure will be described with reference to the drawings.

### <Device Configuration>

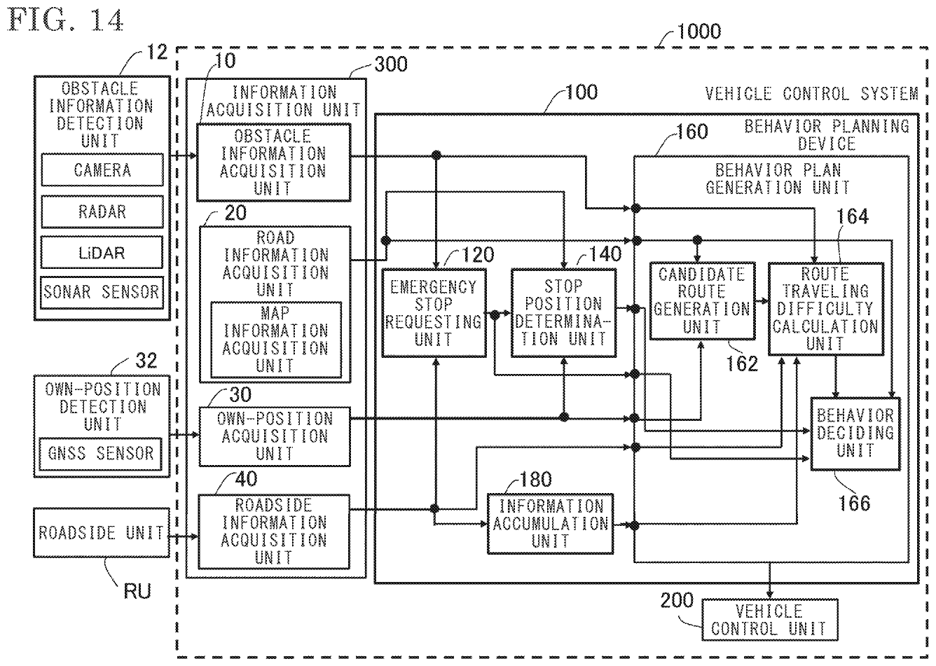

FIG. 14 is a function block diagram showing the configurations of the behavior planning device and the vehicle control system according to the third embodiment. In FIG. 14, the vehicle control system 1000 includes the behavior planning device 100. Here, description of the same matters as in the first and second embodiments is omitted. As shown in FIG. 14, the behavior planning device 300 further includes an information accumulation unit 180 in addition to the configuration of the behavior planning device 100 shown in FIG. 1. The behavior plan generation unit 160 generates a behavior plan for preventing the own vehicle from stopping in the area where advancement of another traffic participant is obstructed, considering also obstacle information acquired by the roadside information acquisition unit and accumulated in the information accumulation unit 180.

The information accumulation unit 180 continues to accumulate obstacle information acquired by the roadside information acquisition unit 40, and outputs the accumulated information to the behavior plan generation unit 160. From the obstacle information accumulated in the information accumulation unit 180, transition of the obstacle information from the past is found. As an output method to the behavior plan generation unit 160, only the obstacle information at a time that is one cycle before a present time t may be outputted, or information that has been measured for T seconds may be outputted together with measurement times, for example. Here, one cycle is the count-up cycle described above.

As in the first and second embodiments (see FIG. 5), the behavior plan generation unit 160 includes the candidate route generation unit 162, the route traveling difficulty calculation unit 164, and the behavior deciding unit 166.

The candidate route generation unit 162 generates a candidate route that can be selected by the own vehicle, on the basis of the road information acquired by the road information acquisition unit 20.

Regarding each candidate route generated by the candidate route generation unit 162, the route traveling difficulty calculation unit 164 calculates a traveling difficulty for traveling, on the basis of the obstacle information acquired from the obstacle information acquisition unit 10, the obstacle information outputted from the roadside information acquisition unit 40, and the obstacle information accumulated in the information accumulation unit 180.

The behavior deciding unit 166 selects a candidate route having the lowest traveling difficulty on the basis of the candidate routes and their respective traveling difficulties calculated by the route traveling difficulty calculation unit 164, and decides a behavior plan for preventing stoppage in the area where advancement of another traffic participant is obstructed.

<Operations of Vehicle Control System 1000 and Behavior Planning Device 100>

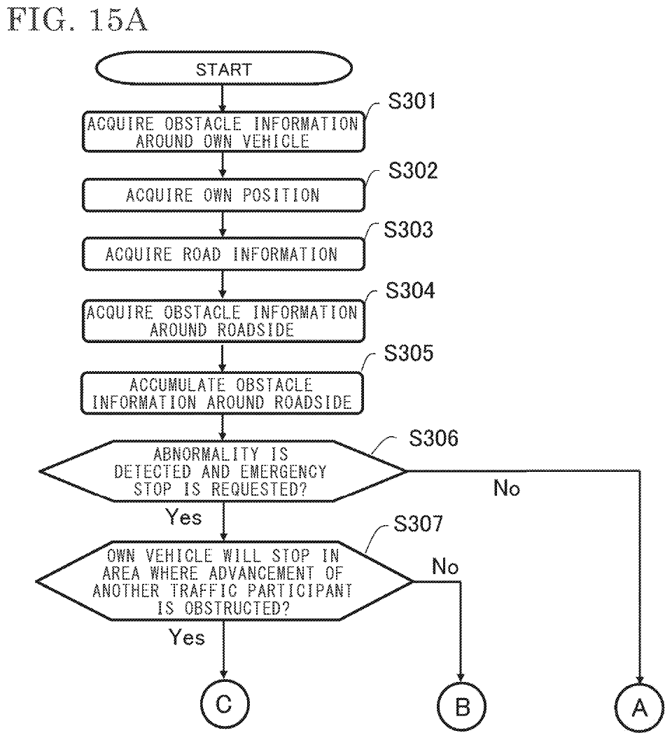

FIG. 15A and FIG. 15B are flowcharts showing the entire operations of the vehicle control system 1000 and the behavior planning device 100 in the third embodiment. The process in the flowcharts in FIG. 15A and FIG. 15B is repeatedly executed during traveling of the own vehicle.

Hereinafter, steps in FIG. 15A and FIG. 15B will be described in association with the function units shown in the function block diagram in FIG. 14. It is noted that operations in steps S301 to S304, S306, S3071 to 33074, 3308, and S309 are the same as operations in steps S101 to S104, S105, S1071 to 31074, S108, and S109 shown in FIG. 4 and FIG. 5 in the first embodiment.

First, in steps S301 to S304, each function unit acquires the corresponding information, as described in the first embodiment.

In step S305, the information accumulation unit 180 accumulates the obstacle information acquired by the roadside information acquisition unit 40.

In step S306, if abnormality is detected for the obstacle information, an emergency stop request is outputted (Yes in step S306). In step S307, the stop position determination unit 140 determines whether or not the own vehicle will stop in the area where advancement of another traffic participant is obstructed. In step S307, if it is determined that the own vehicle will stop in the area where advancement of another traffic participant is obstructed (Yes in step S307), the process proceeds to step S3071.

In step S3071, the candidate route generation unit 162 generates at least one candidate route on the basis of the road information acquired from the road information acquisition unit 20 and the own position acquired from the own-position acquisition unit 30.

In step S3072, regarding each candidate route generated in step S3071, the route traveling difficulty calculation unit 164 calculates a traveling difficulty for the own vehicle to travel, on the basis of the obstacle information acquired from the obstacle information acquisition unit 10, the obstacle information acquired from the roadside information acquisition unit 40, and the obstacle information accumulated in the information accumulation unit 180.

In step S3073, the behavior deciding unit 166 selects a route having the lowest traveling difficulty among the traveling difficulties of the candidate routes calculated by the route traveling difficulty calculation unit 164.

In step 3074, on the basis of the selected route, the behavior deciding unit 166 generates a behavior plan for leading the own vehicle so as to avoid the area where advancement of another traffic participant is obstructed and stop outside the area or in an area where another traffic participant is less influenced, and outputs the behavior plan to the vehicle control unit 200.

### <Operation of Behavior Planning Device 100>

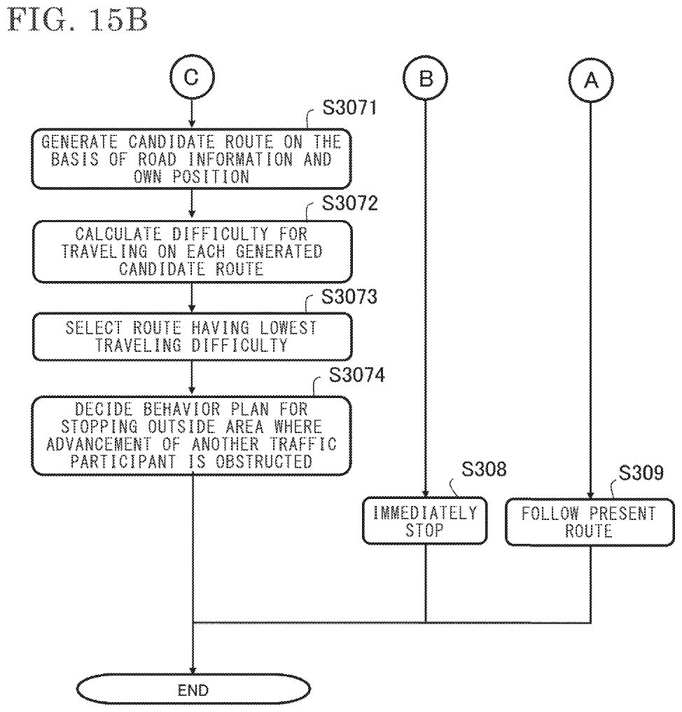

Next, the detailed operation of the behavior planning device 100 according to the third embodiment will be described with reference to FIG. 16 to FIG. 18.

FIG. 16 shows a case where, using obstacle information acquired from the roadside unit RU and the obstacle information detection units 12 which are the obstacle detection sensors provided to the own vehicle OV, the own vehicle OV travels while following the straight route STR acquired from the road information acquisition unit 20, thus passing through an intersection by advancing straight. As in the first and second embodiments, the inner side of the stop lines of the intersection is represented as an area CNF where another traffic participant is greatly influenced. In addition, the roadside unit RU can detect an obstacle in the area RUA. Here, it is detected that another vehicle VE is stopped on the road at a position after the own vehicle OV passes over the intersection by advancing straight. That is, the roadside information acquisition unit 40 acquires the other vehicle VE which is a static obstacle, as obstacle information.

On the basis of the straight route STR passing the lane center and generated so as to pass through the intersection by advancing straight, which is acquired from the road information acquisition unit 20, and the position information acquired from the own-position acquisition unit 30, the own vehicle OV not only travels while following the straight route STR but also travels while avoiding the other vehicle VE which is a static obstacle.

Here, regarding the obstacle information acquired from the roadside information acquisition unit 40, the emergency stop requesting unit 120 determines that abnormality has occurred from a detection result indicating that communication from the roadside unit RU is disrupted. Then, the emergency stop requesting unit 120 outputs an emergency stop request to the stop position determination unit 140 and the behavior plan generation unit 160.

The stop position determination unit 140 calculates the stop position SP at which the own vehicle OV will advance and stop in a case of stopping from the present position on the basis of the emergency stop request, as in the first and second embodiments. As shown in FIG. 16, if the stop position SP is in the area CNF, the stop position determination unit 140 determines that the own vehicle OV will enter and stop in the area CNF, and outputs the determination result to the behavior plan generation unit 160.

From the determination result of the stop position determination unit 140, the candidate route generation unit 162 of the own vehicle OV generates at least one candidate route on the basis of the own-position information acquired from the own-position acquisition unit 30 and the road information acquired from the road information acquisition unit 20. The generation method for the candidate route is the same as in the first and second embodiments. Here, since the intersection is a T junction, the candidate route generation unit 162 generates a straight route STR and a left-turn route LTP as candidate routes, and outputs them to the route traveling difficulty calculation unit 164.

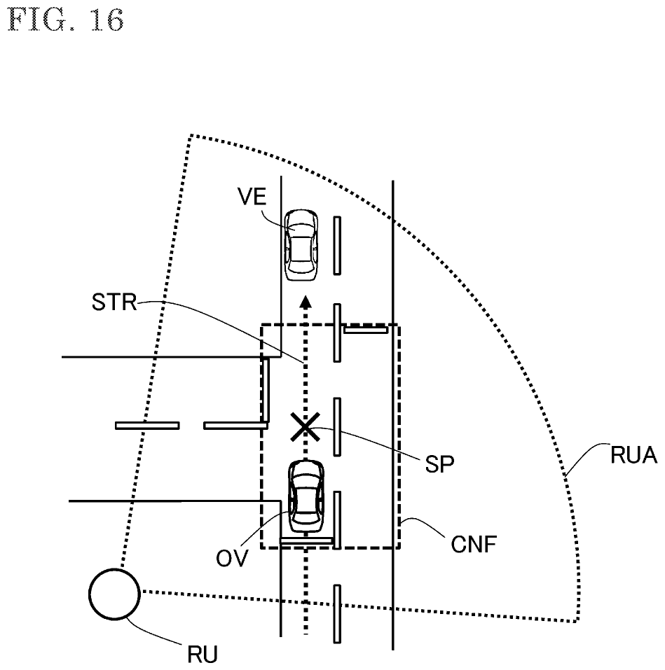

FIG. 17 illustrates a traveling difficulty of each candidate route. Regarding each of the candidate routes generated by the candidate route generation unit, i.e., the straight route STR and the left-turn route LTP, the route traveling difficulty calculation unit 164 calculates a traveling difficulty for the candidate route, using the obstacle information acquired from the obstacle information acquisition unit 10, the own-position information acquired from the own-position acquisition unit 30, the roadside information acquired from the roadside information acquisition unit 40, and the obstacle information accumulated in the information accumulation unit 180.

Here, while the route traveling difficulty calculation unit 164 calculates a traveling difficulty for each candidate route, obstacle information to be acquired from the roadside information acquisition unit 40 cannot be used when communication from the roadside unit RU is disrupted and abnormality is determined. Therefore, as obstacle information obtained from the roadside unit RU, transition of the obstacle information acquired by the information accumulation unit 180 in the past, i.e., the obstacle information that has been accumulated until before abnormality determination, is used. Owing to this information, it is found that another vehicle VE is present in a static state at a position after the own vehicle OV passes over the intersection by advancing straight, on the basis of the obstacle information acquired by the information accumulation unit 180 in the past. Since the obstacle information acquired in the past indicates a static obstacle, the route traveling difficulty calculation unit 164 determines that the obstacle has not greatly moved from that position at present, and estimates that the static obstacle is present on the straight route STR.

For the straight route STR, as in the second embodiment, width information of the other vehicle VE which is an obstacle present on the route is subtracted, to calculate a remaining road width LFW with respect to the width on the straight route STR. In the situation in FIG. 17, it is determined that the remaining road width LFW is smaller than the width of the own vehicle OV, and the own vehicle OV needs to travel while straying onto another lane OL (here, opposite lane) in order to avoid the other vehicle VE which is an obstacle. Here, in the case of traveling while straying onto the other lane OL, it is necessary to consider obstacle information on the other lane OL, but since communication of information from the roadside unit RU is disrupted, it is unclear whether another vehicle appears on the other lane OL, and if another vehicle appears, the own vehicle OV might obstruct traveling of the other vehicle.

In addition, in a case of traveling to a position before the other vehicle VE which is an obstacle and then stopping there, it is necessary to consider the size of an area FSP between the area CNF and the other vehicle VE which is an obstacle. Although there are no obstacles in the area FSP, unless the length of the area FSP is greater than the length of the own vehicle OV by a predetermined value or more, the stop position of the own vehicle OV is included in the area CNF. In the situation in FIG. 17, the length of the area FSP is not greater than the length of the own vehicle OV. Therefore, where an area occupied by the own vehicle OV when the own vehicle OV travels and stops on the straight route STR is defined as an area ESP indicated by a thick frame, it is estimated that the own vehicle OV will stop with a part of the area ESP included in the area CNF. Therefore, a traveling difficulty of the straight route STR is calculated to be high. As described above, in a case where an obstacle is present ahead of the area CNF, if at least a part of the area FSP needed for the own vehicle OV to stop at a position before the obstacle is present in the area CNF, the traveling difficulty is calculated to be high.

On the other hand, regarding the left-turn route LTP, it can be determined that there are no obstacles therearound, using information from the obstacle information detection units 12 which are the obstacle detection sensors provided to the own vehicle OV. Therefore, a traveling difficulty of the route in the left-turn direction is calculated to be low.

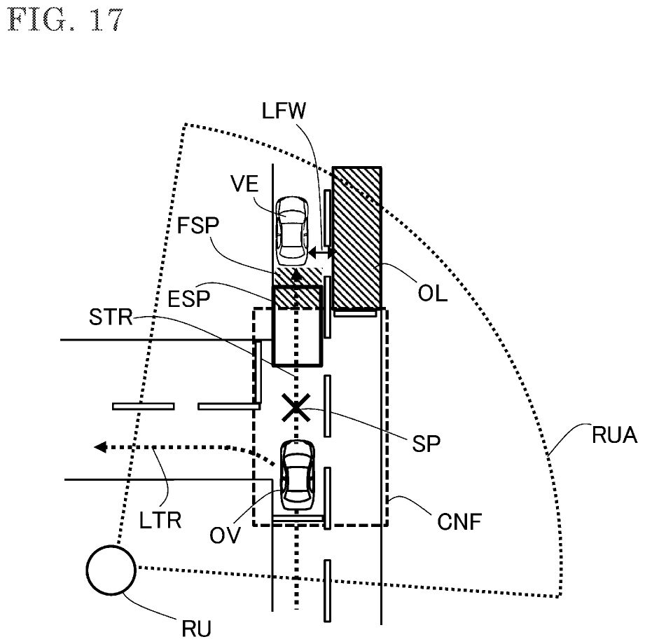

The candidate routes STR, LTR in the two directions and the calculation results of their respective traveling difficulties described above are outputted to the behavior deciding unit 166. As shown in FIG. 18, the behavior deciding unit 166 decides the low-traveling-difficulty left-turn route LTR having the lowest traveling difficulty, as a route for the own vehicle OV to advance. Then, the behavior plan generation unit 160 outputs a behavior plan of stopping at a stop position MRP after passing over the area CNF on the route.

As described above, according to the third embodiment, the same effects as in the first embodiment are provided. That is, it is possible to stop the own vehicle in an area where advancement of another traffic participant is not obstructed and another traffic participant is less influenced, when abnormality is detected on the basis of obstacle information.

Further, since the behavior planning device according to the third embodiment further includes the information accumulation unit, when abnormality is detected for obstacle information acquired from the roadside information acquisition unit, it is possible to estimate the states of obstacles on the basis of information accumulated until occurrence of abnormality. By using these in calculation of difficulties of traveling routes, it becomes possible to calculate more accurate difficulties.

In particular, regarding obstacle information around the own vehicle acquired by the obstacle information acquisition unit, a detectable obstacle information range for an area such as an intersection where another traffic participant is greatly influenced varies as the own vehicle approaches. However, obstacle information acquired by the roadside information acquisition unit is obstacle information sent from the obstacle detection device provided in a roadside area, and therefore it is possible to obtain obstacle information for a predetermined range irrespective of the position of the own vehicle. Therefore, by accumulating the obstacle information acquired by the roadside information acquisition unit, it is possible to advantageously use the accumulated past information in calculating traveling difficulties of candidate routes, because it is considered that the positions of static obstacles do not greatly change even if communication disruption has occurred. Accordingly, even in a case where the detection distance of the obstacle information detection unit (obstacle detection sensor) provided to the own vehicle is short, by complementing information at a long distance with the roadside information, a route having a low traveling difficulty is decided, thus providing an effect that the own vehicle can be prevented from stopping in an area where advancement of another traffic participant is obstructed and can be led to a position where another traffic participant is less influenced.

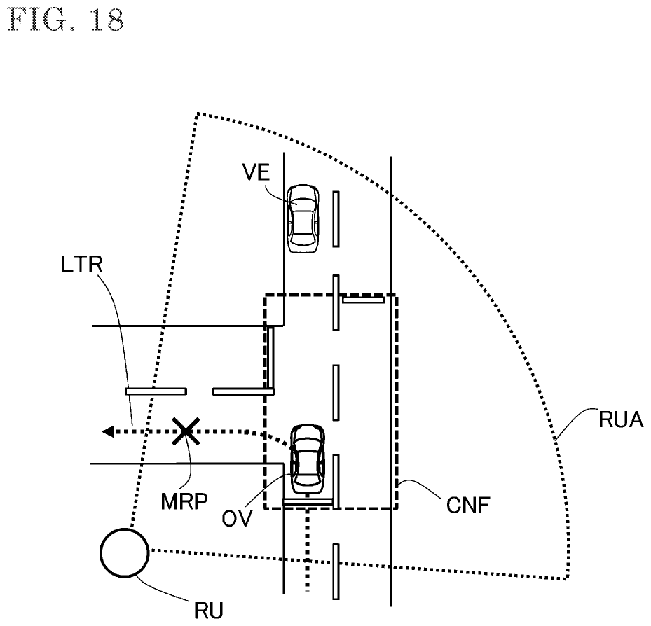

The function units of the behavior planning device 100 according to each of the first to third embodiments may be implemented by a hardware configuration of the vehicle control system 1000 exemplified in FIG. 19, which is composed of a processing circuit 1001, a storage device 1002 including a read only memory (ROM) storing a program for executing the functions of the function units and a random access memory (RAM) storing data of execution results of the function units which are calculation results by the program, and an input/output circuit 1003. The input/output circuit 1003 receives output results about obstacle information from each obstacle information detection unit 12 which is the obstacle detection sensor provided to the own vehicle, output results about own-position information detected by the own-position detection unit 32 and obstacle information from the roadside unit PU, and the like. Then, control signals for the speed of the own vehicle, steering, and the like are outputted from the input/output circuit 1003 to drive-system equipment 2000 which includes the actuators for driving the vehicle, such as the brake and the steering wheel.

For the processing circuit 1001, a processor such as a central processing unit (CPU) or a digital signal processor (DSP) is used. Dedicated hardware may be used for the processing circuit 1001. In a case where the processing circuit 1001 is dedicated hardware, the processing circuit 1001 is, for example, a single circuit, a complex circuit, a programmed processor, a parallel-programmed processor, an application specific integrated circuit (ASIC), a field-programmable gate array (FPGA), or a combination thereof.

The function units of the behavior planning device 100 and the vehicle control system 1000 may be each implemented by an individual processing circuit, or may be collectively implemented by one processing circuit.

Regarding the function units of the behavior planning device 100 and the vehicle control system 1000, some of the functions may be implemented by a processing circuit as dedicated hardware, and other functions may be implemented by software, for example. Thus, the functions described above may be implemented by hardware, software, etc., or a combination thereof.

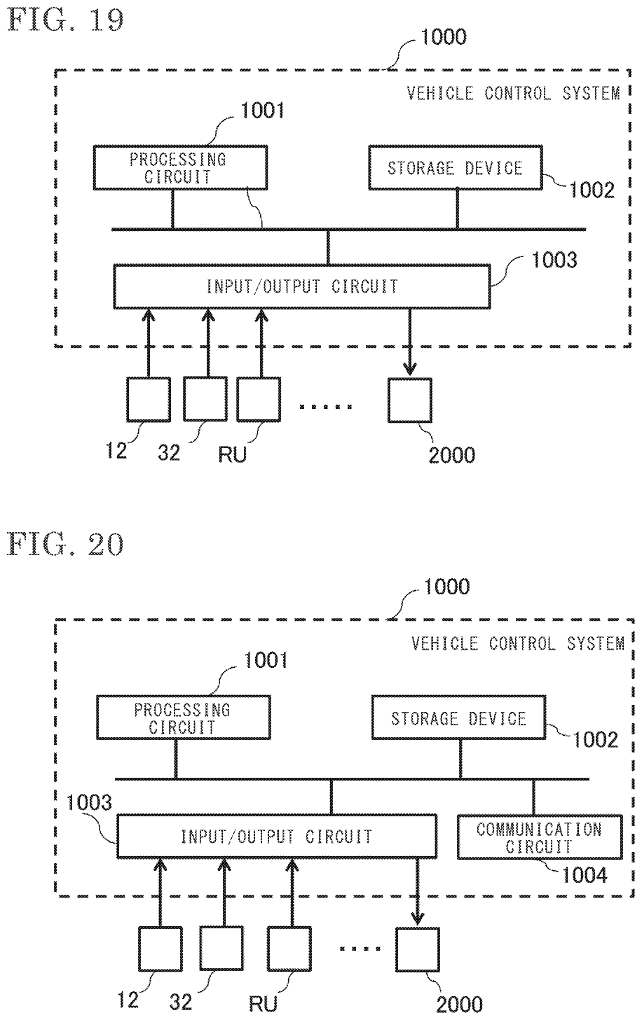

FIG. 20 shows another example of a hardware configuration of the vehicle control system 1000. A communication circuit 1004 is further provided in addition to the configuration in FIG. 19.

The communication circuit 1004 includes a long-range communication unit and a short-range communication unit as a communication module. As the long-range communication unit, the one compliant with a predetermined long-range wireless communication standard such as long term evolution (LTE) or fourth/fifth-generation mobile communication system (4G/5G) is used. For the short-range communication unit, for example, dedicated short range communications (DSRC) are used, and although not shown in the above embodiments, the short-range communication unit may be used for communication with another vehicle, whereby information of another vehicle around the own vehicle can be acquired. For these communications, certain communication speeds are ensured.

The roadside unit RU is provided outside the vehicle or outside a traffic control system, and therefore obstacle information from the roadside unit RU is received through communication by the vehicle control system 1000. For this communication, LTE or 5G is used, for example.

Each sensor of the obstacle information detection unit 12 and the GNSS sensor of the own-position detection unit 32 are mounted to the vehicle, and information from each sensor is outputted to the information acquisition unit 300 via a communication line. For example, they are connected using Controller Area Network (CAN) (registered trademark).

Also in a case where a part of the vehicle control system 1000 is present outside the own vehicle, e.g., in a traffic control system, and emergency stop is activated, transmission and reception of signals are performed by the communication circuit 1004.

### Other Embodiments

In the above description, the case where the mobile object to which the behavior planning device 100 and the vehicle control system 1000 are applied is an automobile which is a vehicle, has been shown as an example. However, the application target is not limited to an automobile, and may be other various movable bodies. The behavior planning device 100 can be used as a device for planning a behavior of a mobile object such as an in-building movable robot for inspecting the inside of a building, a line inspection robot, or a personal mobility, for example. In a case where the mobile object is other than an automobile, regarding detection information by the road information detection unit, a traveling possible area on a route for the mobile object to travel may be acquired as road information. As obstacle information acquired by the roadside unit RU, information from an obstacle information detection unit provided in a building, a line, or a range in which a personal mobility moves, for example, may be used.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

Hereinafter, modes of the present disclosure are summarized as additional notes.

### (Additional Note 1)

A behavior planning device which receives obstacle information around a mobile object acquired by an obstacle information acquisition unit, position information of the mobile object acquired by an own-position acquisition unit, road information around the mobile object acquired by a road information acquisition unit, and obstacle information around a roadside acquired by a roadside information acquisition unit, the behavior planning device comprising:
an emergency stop requesting unit which outputs an emergency stop request when having detected abnormality for at least one of the obstacle information around the mobile object acquired by the obstacle information acquisition unit and the obstacle information around the roadside acquired by the roadside information acquisition unit;
a stop position determination unit which determines whether or not the mobile object will stop in a first area where advancement of another traffic participant is obstructed at a time of stoppage of the mobile object, on the basis of the road information, the position information of the mobile object, and the emergency stop request outputted from the emergency stop requesting unit; and
a behavior plan generation unit which generates a behavior plan for preventing the mobile object from stopping in the first area, in a case where the stop position determination unit has determined that the mobile object will stop in the first area where advancement of another traffic participant is obstructed.

### (Additional Note 2)

The behavior planning device according to additional note 1, wherein
the behavior plan generation unit includes
   a candidate route generation unit which generates at least one candidate route for the mobile object to travel, on the basis of the road information and the position information of the mobile object,
   a route traveling difficulty calculation unit which calculates a traveling difficulty for the mobile object to travel on each candidate route generated by the candidate route generation unit, on the basis of the obstacle information acquired by the obstacle information acquisition unit, the obstacle information around the roadside acquired by the roadside information acquisition unit, the position information of the mobile object, and the abnormality information detected by the emergency stop requesting unit, and
   a behavior deciding unit which selects a traveling route having a lowest traveling difficulty among the traveling difficulties on the candidate routes calculated by the route traveling difficulty calculation unit, and
the behavior plan generation unit generates a behavior plan for the mobile object to stop outside the first area.

### (Additional Note 3)

The behavior planning device according to additional note 2, wherein
the route traveling difficulty calculation unit
   in a case where an obstacle is present ahead of the first area, calculates a second area which is a stop area needed for the mobile object to stop at a position before the obstacle, and
   in a case where at least a part of the second area is present in the first area, calculates a corresponding traveling difficulty to be high.

### (Additional Note 4)

The behavior planning device according to additional note 2 or 3, wherein
the candidate route generation unit generates a planned route for the mobile object to move to a target position, as one of the candidate routes, and
the behavior deciding unit preferentially selects the planned route for the mobile object to move to the target position, in a case where the traveling difficulties are the same.

### (Additional Note 5)

The behavior planning device according to any one of additional notes 1 to 4, further comprising an information accumulation unit which accumulates the obstacle information around the roadside acquired by the roadside information acquisition unit, wherein
in a case where the stop position determination unit has determined that the mobile object will stop in the first area where advancement of another traffic participant is obstructed, the behavior plan generation unit generates a behavior plan for preventing the mobile object from stopping in the first area, considering also the obstacle information accumulated in the information accumulation unit.

### (Additional Note 6)

The behavior planning device according to any one of additional notes 2 to 4, further comprising an information accumulation unit which accumulates the obstacle information around the roadside acquired by the roadside information acquisition unit, wherein
the route traveling difficulty calculation unit calculates the traveling difficulty for the mobile object to travel on each candidate route generated by the candidate route generation unit, considering also the obstacle information accumulated in the information accumulation unit.

### (Additional Note 7)

The behavior planning device according to additional note 5, wherein
in a case where the emergency stop requesting unit has detected abnormality for the obstacle information around the roadside acquired by the roadside information acquisition unit, the behavior plan generation unit generates a behavior plan for preventing the mobile object from stopping in the first area, using the obstacle information accumulated in the information accumulation unit, without using the obstacle information around the roadside acquired by the roadside information acquisition unit.

### (Additional Note 3)

The behavior planning device according to any one of additional notes 1 to 7, further comprising the obstacle information acquisition unit, the own-position acquisition unit, the road information acquisition unit, and the roadside information acquisition unit.

### (Additional Note 9)

A vehicle control system comprising:
the behavior planning device according to any one of additional notes 1 to 8; and
a vehicle control unit which controls the mobile object.

### (Additional Note 10)

A behavior plan generation method executed using a behavior planning device, the method comprising:
a step of acquiring obstacle information around a mobile object;
a step of acquiring position information of the mobile object;
a step of acquiring road information around the mobile object;
a step of acquiring obstacle information around a roadside;
a step of outputting an emergency stop request when abnormality is detected for at least one of the obstacle information around the mobile object and the obstacle information around the roadside that have been acquired;
a step of determining whether or not the mobile object will stop in an area where advancement of another traffic participant is obstructed at a time of stoppage of the mobile object, on the basis of the road information and the position information of the mobile object that have been acquired and the outputted emergency stop request; and
a step of generating a behavior plan for preventing the mobile object from stopping in the area, in a case where it is determined that the mobile object will stop in the area.

### (Additional Note 11)

The behavior plan generation method according to additional note 30, wherein
the step of generating the behavior plan includes
   a step of generating at least one candidate route for the mobile object to travel, on the basis of the road information and the position information of the mobile object,
   a step of calculating a traveling difficulty for the mobile object to travel on each candidate route, on the basis of the obstacle information around the mobile object, the obstacle information around the roadside, the position information of the mobile object, and the detected abnormality information,
   a step of selecting a traveling route having a lowest traveling difficulty among the calculated traveling difficulties, and
   a step of generating a behavior plan for the mobile object to stop outside the area, on the basis of the selected traveling route.

### (Additional Note 12)

The behavior plan generation method according to additional note 10 or 11, further comprising a step of accumulating the acquired obstacle information around the roadside after the step of acquiring the obstacle information around the roadside, wherein
in the step of generating the behavior plan, the behavior plan for the mobile object is generated, considering also the accumulated obstacle information around the roadside.

### DESCRIPTION OF THE REFERENCE CHARACTERS

10 obstacle information acquisition unit
12, 12a, 12b, 12c, 12d, 12e, 12f, 12g obstacle information detection unit
20 road information acquisition unit
30 own-position acquisition unit
32 own-position detection unit
40 roadside information acquisition unit
100 behavior planning device
120 emergency stop requesting unit
140 stop position determination unit
160 behavior plan generation unit
162 candidate route generation unit
164 route traveling difficulty calculation unit
166 behavior deciding unit
180 information accumulation unit
200 vehicle control unit
300 information acquisition unit
1000 vehicle control system
1001 processing circuit
3002 storage device
1003 input/output circuit
1004 communication circuit
2000 drive-system equipment
OV own vehicle
RU roadside unit
RUA area
CNF area
VE other vehicle
SN1, SN2, SN3, SN4, SN5, SN6, SN7 detection range
SL, SL1, SL2, SL3, SL4 stop line
SP, MRP stop position
STR straight route
LTR left-turn route
RTR right-turn route
PD, PD1, PD2 pedestrian
RW, RW1, RW2 road width
LFW remaining road width
FSP area
ESP area
OL other lane

What is claimed is:

1. A behavior planning device to receive obstacle information around a mobile object acquired by an obstacle information acquirer, position information of the mobile object acquired by an own-position acquirer, road information around the mobile object acquired by a road information acquirer, and obstacle information around a roadside acquired by a roadside information acquirer, the behavior planning device comprising:
an emergency stop requester to output an emergency stop request when having detected abnormality for at least one of the obstacle information around the mobile object acquired by the obstacle information acquirer and the obstacle information around the roadside acquired by the roadside information acquirer;
a stop position determiner to determine whether or not the mobile object will stop in a first area where advancement of another traffic participant is obstructed at a time of stoppage of the mobile object, on the basis of the road information, the position information of the mobile object, and the emergency stop request outputted from the emergency stop requester; and
a behavior plan generator to generate a behavior plan for preventing the mobile object from stopping in the first area, in a case where the stop position determiner has determined that the mobile object will stop in the first area where advancement of another traffic participant is obstructed.

2. The behavior planning device according to claim 1, wherein
the behavior plan generator includes
a candidate route generator to generate at least one candidate route for the mobile object to travel, on the basis of the road information and the position information of the mobile object,
a route traveling difficulty calculator to calculate a traveling difficulty for the mobile object to travel on each candidate route generated by the candidate route generator, on the basis of the obstacle information acquired by the obstacle information acquirer, the obstacle information around the roadside acquired by the roadside information acquirer, the position information of the mobile object, and the abnormality information detected by the emergency stop requester, and
a behavior decider to select a traveling route having a lowest traveling difficulty among the traveling difficulties on the candidate routes calculated by the route traveling difficulty calculator, and
the behavior plan generator generates a behavior plan for the mobile object to stop outside the first area.

3. The behavior planning device according to claim 2, wherein
the route traveling difficulty calculator
in a case where an obstacle is present ahead of the first area, calculates a second area which is a stop area needed for the mobile object to stop at a position before the obstacle, and
in a case where at least a part of the second area is present in the first area, calculates a corresponding traveling difficulty to be high.

4. The behavior planning device according to claim 2, wherein
the candidate route generator generates a planned route for the mobile object to move to a target position, as one of the candidate routes, and
the behavior decider preferentially selects the planned route for the mobile object to move to the target position, in a case where the traveling difficulties are the same.

5. The behavior planning device according to claim 1, further comprising an information accumulator to accumulate the obstacle information around the roadside acquired by the roadside information acquirer, wherein
in a case where the stop position determiner has determined that the mobile object will stop in the first area where advancement of another traffic participant is obstructed, the behavior plan generator generates a behavior plan for preventing the mobile object from stopping in the first area, considering also the obstacle information accumulated in the information accumulator.

6. The behavior planning device according to claim 2, further comprising an information accumulator to accumulate the obstacle information around the roadside acquired by the roadside information acquirer, wherein
the route traveling difficulty calculator calculates the traveling difficulty for the mobile object to travel on each candidate route generated by the candidate route generator, considering also the obstacle information accumulated in the information accumulator.

7. The behavior planning device according to claim 5, wherein
in a case where the emergency stop requester has detected abnormality for the obstacle information around the roadside acquired by the roadside information acquirer, the behavior plan generator generates a behavior plan for preventing the mobile object from stopping in the first area, using the obstacle information accumulated in the information accumulator, without using the obstacle information around the roadside acquired by the roadside information acquirer.

8. The behavior planning device according to claim 1, further comprising the obstacle information acquirer, the own-position acquirer, the road information acquirer, and the roadside information acquirer.

9. A vehicle control system comprising:
the behavior planning device according to claim 1; and
a vehicle controller to control the mobile object.

10. A behavior plan generation method executed using a behavior planning device, the method comprising:
a step of acquiring obstacle information around a mobile object;
a step of acquiring position information of the mobile object;
a step of acquiring road information around the mobile object;
a step of acquiring obstacle information around a roadside;
a step of outputting an emergency stop request when abnormality is detected for at least one of the obstacle information around the mobile object and the obstacle information around the roadside that have been acquired;
a step of determining whether or not the mobile object will stop in an area where advancement of another traffic participant is obstructed at a time of stoppage of the mobile object, on the basis of the road information and the position information of the mobile object that have been acquired and the outputted emergency stop request; and
a step of generating a behavior plan for preventing the mobile object from stopping in the area, in a case where it is determined that the mobile object will stop in the area.

11. The behavior plan generation method according to claim 10, wherein
the step of generating the behavior plan includes
a step of generating at least one candidate route for the mobile object to travel, on the basis of the road information and the position information of the mobile object,
a step of calculating a traveling difficulty for the mobile object to travel on each candidate route, on the basis of the obstacle information around the mobile object, the obstacle information around the roadside, the position information of the mobile object, and the detected abnormality information,
a step of selecting a traveling route having a lowest traveling difficulty among the calculated traveling difficulties, and
a step of generating a behavior plan for the mobile object to stop outside the area, on the basis of the selected traveling route.

12. The behavior plan generation method according to claim 10, further comprising a step of accumulating the acquired obstacle information around the roadside after the step of acquiring the obstacle information around the roadside, wherein
in the step of generating the behavior plan, the behavior plan for the mobile object is generated, considering also the accumulated obstacle information around the roadside.

13. The behavior planning device according to claim 3, wherein
the candidate route generator generates a planned route for the mobile object to move to a target position, as one of the candidate routes, and
the behavior decider preferentially selects the planned route for the mobile object to move to the target position, in a case where the traveling difficulties are the same.

14. The behavior planning device according to claim 2, further comprising an information accumulator to accumulate the obstacle information around the roadside acquired by the roadside information acquirer, wherein
in a case where the stop position determiner has determined that the mobile object will stop in the first area where advancement of another traffic participant is obstructed, the behavior plan generator generates a behavior plan for preventing the mobile object from stopping in the first area, considering also the obstacle information accumulated in the information accumulator.

15. The behavior planning device according to claim 3, further comprising an information accumulator to accumulate the obstacle information around the roadside acquired by the roadside information acquirer, wherein
in a case where the stop position determiner has determined that the mobile object will stop in the first area where advancement of another traffic participant is obstructed, the behavior plan generator generates a behavior plan for preventing the mobile object from stopping in the first area, considering also the obstacle information accumulated in the information accumulator.

16. The behavior planning device according to claim 3, further comprising an information accumulator to accumulate the obstacle information around the roadside acquired by the roadside information acquirer, wherein
the route traveling difficulty calculator calculates the traveling difficulty for the mobile object to travel on each candidate route generated by the candidate route generator, considering also the obstacle information accumulated in the information accumulator.

17. The behavior planning device according to claim 14, wherein
in a case where the emergency stop requester has detected abnormality for the obstacle information around the roadside acquired by the roadside information acquirer, the behavior plan generator generates a behavior plan for preventing the mobile object from stopping in the first area, using the obstacle information accumulated in the information accumulator, without using the obstacle information around the roadside acquired by the roadside information acquirer.

18. A vehicle control system comprising:
the behavior planning device according to claim 2; and
a vehicle controller to control the mobile object.

19. The behavior plan generation method according to claim 11, further comprising a step of accumulating the acquired obstacle information around the roadside after the step of acquiring the obstacle information around the roadside, wherein
in the step of generating the behavior plan, the behavior plan for the mobile object is generated, considering also the accumulated obstacle information around the roadside.

20. A vehicle control system comprising:
the behavior planning device according to claim 16; and
a vehicle controller to control the mobile object.
